(19) United States
(12) Patent Application Publication
(10) Pub. No.: US 2007/0247421 A1
(43) Pub. Date: Oct. 25, 2007

(54) Capacitive-based rotational positioning input device

(76) Inventors: Timothy James Orsley, San Jose, CA (US); Jonah Harley, Mountain View, CA (US); Thomas Patrick Murphy, Fremont, CA (US); Alla Shapiro, Mountain View, CA (US)

Correspondence Address: Kathy Manke;Avago Technologies Limited, 4380 Ziegler Road, Fort Collins, CO, 80525, US

(21) Appl. No.: 11/606,560

(22) Filed: Nov. 30, 2006

Related U.S. Application Data
(60) Provisional application No. 60/794,889, filed on Apr. 25, 2006.

(51) Int. Cl. G09G 5/00

(52) U.S. Cl. 345/156

(57) ABSTRACT

An input device includes an electrode base and a code wheel rotatably mounted and vertically spaced relative to the electrode base. The electrode base includes a first array of circumferentially spaced sense electrodes, an array of non-conductive portions interposed between adjacent respective sense electrodes, and at least one drive electrode. The code wheel includes an array of circumferentially spaced apart conductive portions and an array of non-conductive portions interposed between adjacent respective conductive portions of the code wheel. The controller is configured to capture user inputs based on an output signal produced via capacitive coupling of the at least one drive electrode of the electrode base, via the code wheel, to the respective sense electrodes of the electrode base.

### CROSS-REFERENCE TO RELATED APPLICATIONS

This application claims the benefit of the filing date of Provisional U.S. Patent application Ser. No. 60/794,889 entitled “ROTATIONAL POSITIONING INPUT DEVICE”, having Attorney Docket Number A310.279.101, and having a filing date of Apr. 25, 2006, which is incorporated herein by reference.

### BACKGROUND

The optical mouse has been overwhelmingly popular for controlling functions of computers and other electronic devices. However, the conventional optical mouse is too big and unsuitable for use in many portable electronic devices such as personal digital assistants, telephones, etc. Accordingly, other types of conventional input devices, such as TouchPad™ devices, jog dials, scroll wheels, and puck-based input devices, have been developed and embedded into portable electronic devices, such as laptop computers, phones, etc. These input devices have become more important as portable electronic devices continue to incorporate more functionality, such as electronic mail, wireless computing, photography, music, etc.

In some instances, a portable electronic device includes a conventional scroll wheel to enable scrolling a long list of songs or other items to enable viewing the list and selecting an item from the list. One conventional input device includes a rotatable wheel for scrolling items on a list and at least one switch for activating a selection highlighted via a rotational position of the wheel.

Users continue to demand more precision and accuracy in user input devices of portable electronic devices, while designers face continual pressure to reduce sizes and increase functionality. With these challenges, conventional input devices continue to fall short of market expectations.

### BRIEF DESCRIPTION OF THE DRAWINGS

FIG. 1 is a top plan view of an electronic device including an input device, according to an embodiment of the invention.

FIG. 2 is sectional view of the input device as taken along lines 2-2 of FIG. 1, according to an embodiment of the invention.

FIG. 3A is a top plan view of an electrode base of an input device, according to an embodiment of the invention.

FIG. 3B is a top plan view of a code wheel of an input device, according to an embodiment of the invention.

FIG. 4A is a top plan view of a positioner of an input device including an electrode base and a code wheel, according to an embodiment of the invention.

FIG. 4B is a sectional view of the positioner of FIG. 4A as taken along lines 4B-B, according to an embodiment of the invention.

FIG. 4C is a diagram of a circuit corresponding to a positioner of an input device, according to an embodiment of the invention.

FIG. 5 is a graph illustrating an output signal corresponding to rotational positioning using an input device, according to an embodiment of the invention.

FIG. 6 is top plan view of a code wheel of an input device, according to an embodiment of the invention.

FIG. 7A is a top plan view of an electrode base of an input device, according to an embodiment of the invention.

FIG. 7B is a top plan view of an electrode base of an input device, according to an embodiment of the invention.

FIG. 7C is a graph illustrating an output signal corresponding to rotational positioning using an input device, according to an embodiment of the invention.

FIG. 8A is a top plan view of a code wheel of an input device, according to an embodiment of the invention.

FIG. 8B is a top plan view of an electrode base of an input device, according to an embodiment of the invention.

FIG. 9A is a top plan view of a code wheel of an input device, according to an embodiment of the invention.

FIG. 9B is a top plan view of an electrode base of an input device, according to an embodiment of the invention.

FIG. 10 is a top plan view of a positioner of an input device including an electrode base and a code wheel, according to an embodiment of the invention.

FIG. 11 is a graph illustrating an output signal corresponding to rotational positioning using an input device, according to an embodiment of the invention.

FIG. 12A is a top plan view of an electrode base of an input device, according to an embodiment of the invention.

FIG. 12B is a top plan view of a positioner of an input device including an electrode base and a code wheel, according to an embodiment of the invention.

FIG. 13A is a top plan view of an electrode base of an input device, according to an embodiment of the invention.

FIG. 13B is a top plan view of a code wheel of an input device, according to an embodiment of the invention.

FIG. 13C is a top plan view of a positioner of an input device including an electrode base and a code wheel with the code wheel in one rotational position, according to an embodiment of the invention.

FIG. 13D is a top plan view of the positioner of FIG. 13C in a second position with the code wheel in another rotational position, according to an embodiment of the invention.

FIG. 13E is a top plan view of an alternate positioner of an input device including an electrode base and a code wheel with the code wheel in one rotational position, according to an embodiment of the invention

FIG. 14A is a side view of a scroll wheel of an input device, according to an embodiment of the invention.

FIG. 14B is a front plan view of a scroll wheel of an input device, according to an embodiment of the invention.

FIG. 15 is a sectional view of a rotational positioner of an input device, according to an embodiment of the invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

Embodiments of the invention are directed to an input device. In one embodiment, an input device is incorporated into a portable electronic device and is configured to capture user inputs associated with functions of the electronic device. In one embodiment, the input device includes a mechanism for rotational positioning of a code wheel relative to an electrode base. A signal based on capacitive coupling between the code wheel and the electrode base varies in amplitude based on a particular rotational position of one or more conductive portions of the code wheel relative to one or more electrode portions of the electrode base. One or more selected configurations of conductive portions and non-conductive portions on a code wheel, and complimentary configurations of electrode sensing portions and electrode drive portions, are arranged to achieve robust identification of rotational user inputs based on the capacitively coupled signal produced by interaction of the code wheel relative to the electrode base.

In one embodiment, the input device has a low profile (e.g., small z height) and/or a small footprint to enhance miniaturization of a portable electronic device into which the input device is incorporated. In one aspect, the small footprint is achieved via incorporating one or more dome switches in a position underneath a rotatable code wheel instead of placement laterally external to a jog dial as occurs in some conventional input devices.

In another aspect, the low profile of the input device, according to embodiments of the invention, is achieved by employing a thin, disc shaped code wheel in combination with dome switches that can be actuated without a conventional vertically oriented stem typically provided to actuate the dome switches.

In one embodiment, the input device incorporates duplicate arrangements of electrode sense portions and electrode drive portions on an electrode base, as well as complimentary duplicate arrangements of conductive portions and non-conductive portions on a code wheel. This arrangement minimizes significant fluctuations in the relative magnitude of an output signal arising from tilting the code wheel relative to the electrode base, such as when a user tilts the code wheel downward to activate a dome switch positioned below the code wheel.

Accordingly, various aspects of embodiments of the invention enable a low profile input device having a robust mechanism for capturing user input associated with a rotational position of code wheel relative to an electrode base.

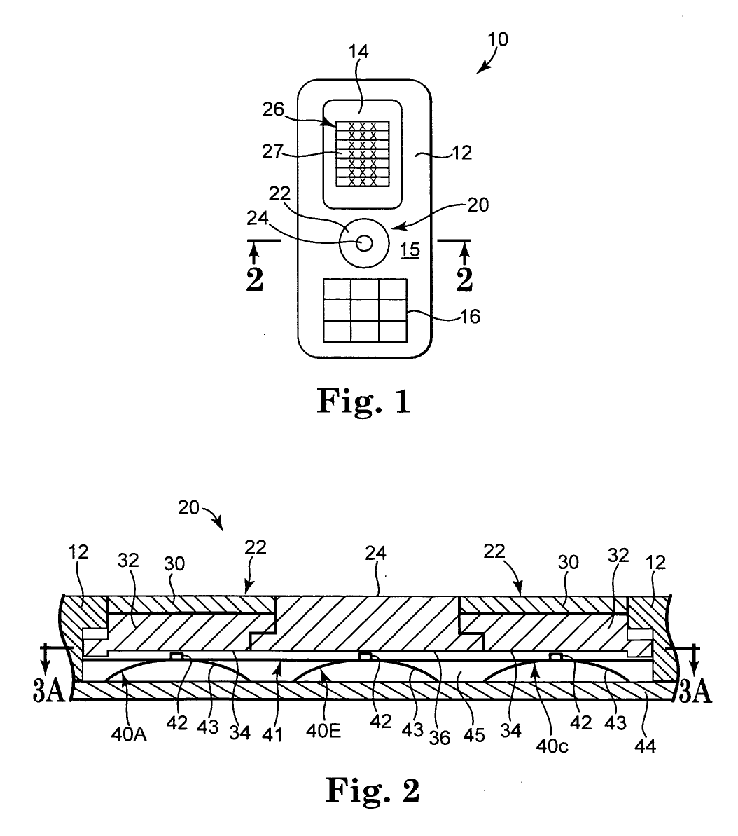

These embodiments and other embodiments of the invention are described and illustrated in association with FIGS. 1-14.

Embodiments of the invention are also particularly well suited for implementation on a laptop computer or other host apparatus such as portable electronic devices (e.g., mobile phones, personal digital assistants, portable audio players, etc.) having limited space for an input device. FIG. 1 is a diagram illustrating a top view of a portable electronic device 10 including an input device 20, according to one embodiment of the present invention. In one embodiment, portable electronic device 10 is a wireless mobile phone. In other embodiments, device 10 is any type of portable electronic device including an input device 20 for capturing user control inputs, including but not limited to a personal digital assistant (PDA), digital camera, portable game device, pager, portable music player, and handheld computer. In other embodiments, device 10 is a portable computer, such as a notebook computer.

As shown in FIG. 1, device 10 comprises housing 12 which carries display 14 and the input device 20. In one embodiment, device 10 additionally comprises a keypad 16. Display 14 comprises a screen capable of displaying a cursor, positional identifiers, navigation elements, and/or other navigable functions, etc. In one aspect, display 14 comprises one or more elements of a graphical user interface (GUI) including, but not limited to menu 26 (or list) of items 27. In another aspect, a positional identifier of display 14 comprises a highlighted portion identifying one or more items 27 on menu 26 or list 26. In one aspect, keypad 16 comprises one or more activatable keys representing numbers, letters, or other symbols.

In one embodiment, as illustrated in FIG. 1, input device 20 comprises scroll wheel 22 and center button 24. In one aspect, input device 20 is mounted on a face 15 of housing 12 of electronic device 10. Rotational movement of scroll wheel 22 captures user control inputs associated with electronic device 10, such as navigating and selecting functions associated with display 20. In one aspect, rotation of scroll wheel 22 causes scrolling up or down a menu 26 of items 27 shown on display 14. In one aspect, center button 24 comprises a switch to enable activating at least one function selected or highlighted via a rotational position of scroll wheel 22. In one aspect, input device 20 comprises additional input switches that are incorporated within input device 20 below scroll wheel 22 to enable further navigation and/or activation of functions associated with display 14 and/or associated generally with electronic device 10.

These aspects, and additional aspects of input device 20, according to embodiments of the invention, are described and illustrated in greater detail in association with FIGS. 2-16.

FIG. 2 is a sectional view of input device 20, according to one embodiment of the invention. As illustrated in FIG. 2, input device 20 comprises scroll wheel 22 and center button 24 as supported within casing 12. In one embodiment, scroll wheel 22 of input device 12 comprises a generally annular shaped non-conductive disc 30 including a conductor pattern 32. While disc 30 is enlarged in FIG. 2 for illustrative clarity, it is understood that the non-conductive disc 30 is a generally thin member and conductor pattern 32 is formed on the non-conductive disc 30 as a pattern of conductive traces.

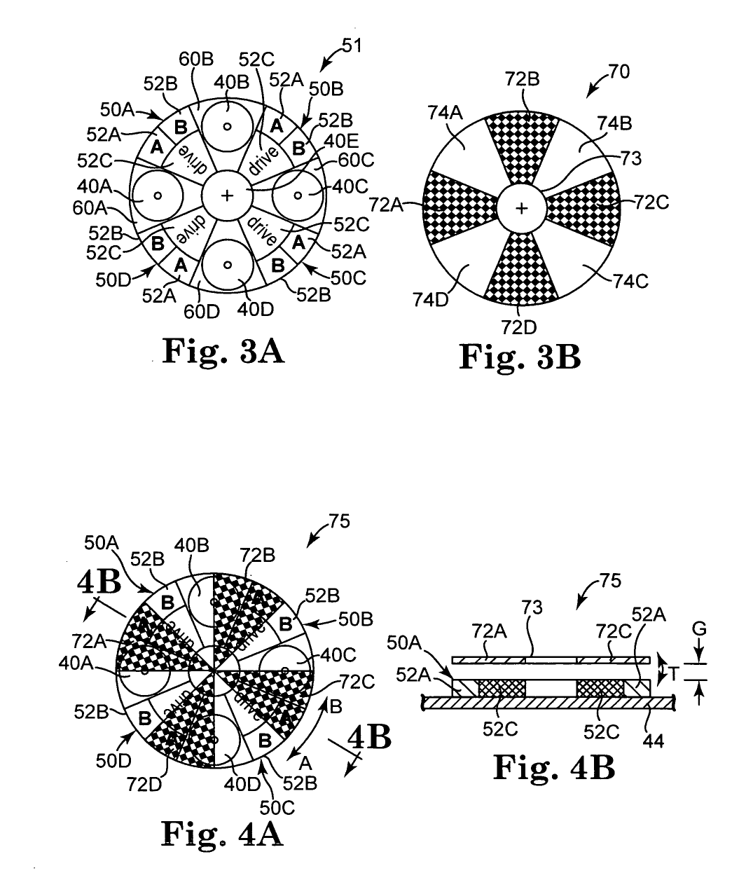

In one aspect, additional embodiments illustrating discs with conductor patterns having substantially the same attributes and features as disc 30 with conductor pattern 32 are illustrated in FIGS. 3B, 6, 8A, 9A, 10, 12B and 13B, as described more fully later in this application. Accordingly, in these embodiments, a disc includes a conductor pattern that comprises an array of conductive portions arranged in a variety of configurations with non-conductive portions interposed between adjacent conductive portions.

In another embodiment, as illustrated in FIG. 2, input device 20 also comprises an electrode base 44 comprising a printed circuit board or flexible printed circuit 44 including an array of sensing electrodes for capacitive interaction with conductor pattern 32 of scroll wheel 22 and including an array of dome switches 40A-40 E, including the illustrated dome switches 40A, 40C, and 40E with dome switches 40B and 40D not shown in FIG. 2 for illustrative clarity. In one aspect, each respective dome switch 40A-40E comprises a generally dome-shaped body 43. In one aspect, central button 24 is aligned for activation of central dome switch 40E and is vertically movable independent of scroll wheel 22.

In one embodiment, a sheet 41 is interposed between the respective dome switches 40A-40E and scroll wheel 22 (and button 24). In one aspect, an array of stems 42 is disposed on sheet 41 to extend generally vertically upward between sheet 41 and scroll wheel 22. The stems 42 are arranged in a pattern generally corresponding to the pattern of dome switches 40A-40E with each stem 42 disposed generally above a respective dome switch 40A-40E. Each respective stem 42 substantially occupies the space 41 between the respective dome switches 40A-40E and scroll wheel 22. Each stem 42 is sized and shaped to facilitate contact between one of the respective dome switches 40A-40E and a bottom surface 34 of conductor pattern 32 so that downward finger pressure on scroll wheel 22 activates a respective dome switch 40A-40E. In one aspect, surface 34 of disc 30 (including conductor pattern 32) of scroll wheel 22 is substantially flat and free of any protrusions on surface 34. This arrangement achieves a lower profile input device 20.

Accordingly, scroll wheel 22 rotates independent of dome switches 40A-40E enabling conductor pattern 32 of scroll wheel 22 to mechanically float relative to the dome switches 40A-40D. This arrangement facilitates free rotation of conductor pattern 32 relative to an electrode base of printed circuit board 44, thereby enhancing a scrolling function of scroll wheel 22.

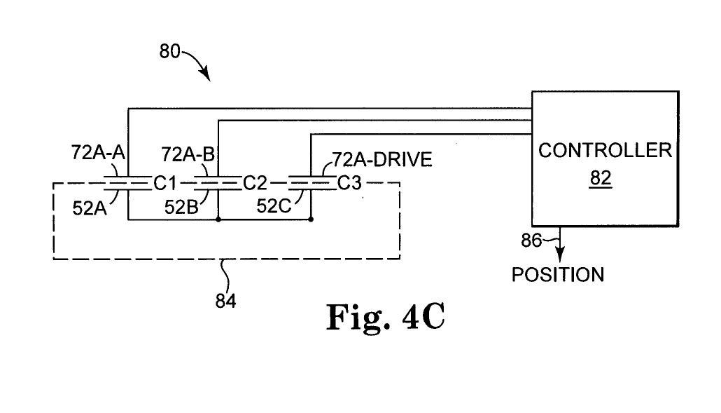

In addition, in another aspect, as further illustrated in FIGS. 3A and 4A, dome switches 40A-40D are positioned beneath scroll wheel 22 instead of placement laterally external of a rotational wheel (e.g. jog dial) as typically occurs in many conventional input devices. This aspect enables reducing a footprint of the input device relative to the housing 12 of the portable electronic device 10 (FIG. 1), facilitating further miniaturization of electronic devices and their input devices.

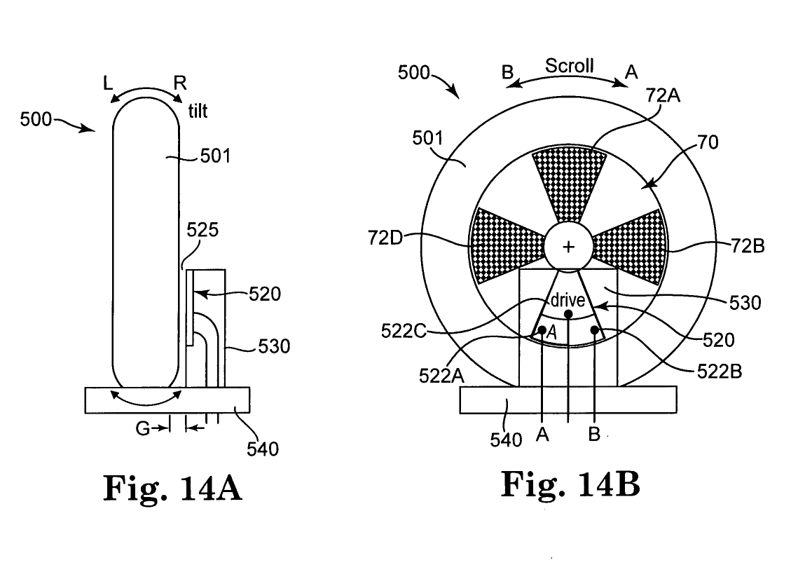

In another embodiment, each respective dome switch 40A-40E omits protrusion 42 and is activated via a dome-actuator frame interposed vertically between the disc 30 and the respective dome switches 40A-40E, as described in association with FIG. 14.

FIG. 3A is a top plan view of an electrode base 51 of an input device, according to one embodiment of the invention. In one embodiment, electrode base 51 comprises substantially the same features and attributes as electrode base 44 of FIG. 2. Accordingly, electrode base 51 defines a generally stationary bottom portion of a generally two-part input device with a wheel 70 (FIG. 3B) comprising an upper portion of the input device, although the input device is not strictly limited to two parts. In one embodiment, electrode base 51 is formed by arranging conductive traces or pads on a printed circuit board with the printed circuit board comprising an integrated circuit configured to drive and control a signal through conductive spokes 50A-50D of electrode base 51.

In one embodiment, as illustrated in FIG. 3A, electrode base 51 comprises a generally disc shaped member including plurality of conductive spokes 50A-50D, which are spaced apart circumferentially about electrode base 51, and a plurality of non-conductive spokes 60A-60D which are interposed between adjacent conductive spokes 50A-50D. This arrangement achieves an alternating pattern between respective conductive spokes 50A-50D and the respective non-conductive spokes 60A-60D. In one aspect, the respective dome switches 40A-40D are circumferentially spaced apart about 90 degrees and the respective conductive spokes 50A-50D are circumferentially spaced apart about 90 degrees.

In one embodiment, each non-conductive spoke 60A-60D of electrode base 51 supports one of the respective dome switches 40A-40D with central dome switch 40E positioned adjacent a center portion of electrode base 51. Accordingly, the respective dome switches 40A-40D are interposed circumferentially between adjacent conductive spokes 50A-50D of electrode base 51.

In one aspect, dome switches 40A-40D are formed directly on the same printed circuit board as conductive spokes 50A-50D to minimize the profile (i.e., vertical dimension) of the input device 20. This arrangement is in contrast to some conventional touch-based input devices which mount a dome switch on the back of a capacitive sense circuit board, resulting in relatively thicker profile. In addition, as previously mentioned, interposing dome switches 40A-40E between adjacent conductive spokes 50A-50D, reduces the footprint of the input device.

In one embodiment, as illustrated in FIG. 3A, each respective conductive spoke 50A-50D of electrode base 51 comprises a first sense electrode 52A, a second sense electrode 52A, and a drive electrode 52C, all of which are electrically isolated from each other as formed on a printed circuit board defining electrode base 51. The respective first sense electrodes 52A of spokes 50A-50D are electrically connected to each other to define a common first sense electrode while the respective second sense electrodes 52B of spokes 50A-50D are electrically connected to each other to define a common second sense electrode. In one aspect, the respective drive electrodes 52C of spokes 50A-50D are electrically connected to each other to define a common drive electrode.

FIG. 3B is a top plan view of a code wheel 70 of an input device, according to one embodiment of the invention. In one embodiment, code wheel 70 comprises substantially the same features and attributes as scroll wheel 22 of FIG. 2 as well additional features described in association with at least FIG. 3B. Accordingly, code wheel 70 defines an upper portion of the input device that is rotatable relative to the generally stationary electrode base 51.

In one embodiment, as illustrated in FIG. 3B, code wheel 70 comprises a generally annular shaped disc including plurality of conductive spokes 72A-72D, which are spaced apart circumferentially about code wheel 70, and a plurality of non-conductive spokes 74A-74D which are interposed between adjacent conductive spokes 72A-72D. This arrangement achieves an alternating pattern between respective conductive spokes 72A-72D and the respective non-conductive spokes 74A-74D. In one aspect, code wheel 70 comprises a central portion 73 defining a hub for conductive spokes 72A-72D and non-conductive spokes 74A-74D. In one aspect, central portion 73 defines a hole while in another aspect, central portion 73 defines a solid member.

In another aspect, each conductive spoke 72A-72D of code wheel 70 defines a generally pie-shaped portion that extends radially outward from the central hole 73 of code wheel 70. In one aspect, code wheel 70 has a size (e.g., a diameter) and a shape generally corresponding to a size and shape of disc shaped electrode base 51 illustrated in FIG. 3A. In one aspect, conductive spokes 72A-72D of code wheel 70 are circumferentially spaced apart about 90 degrees from each other and non-conductive spokes 74A-74D of code wheel 70 are circumferentially spaced apart about 90 degrees from each other.

In one embodiment, the respective conductive spokes 72A-72D of code wheel 70 are connected to each other to define a common conductive element. In another embodiment, the respective conductive spokes 72A-72D of code wheel 70 are not electrically connected to each other.

FIG. 4A is a top plan view of a positioner 75 of an input device, according to one embodiment of the invention. In one embodiment, positioner 75 comprises electrode base 51 and code wheel 70, each of which comprises substantially the same features and attributes as electrode base 51 and code wheel 70 of FIGS. 3A-3B. In one aspect, as illustrated in FIG. 4B, code wheel 70 is positioned in a vertically spaced apart relationship (represented by gap G) above electrode base 51. In one aspect, FIG. 4A illustrates non-conductive spokes 74A-74D are transparent members for clarity in illustrating the overlap and rotational positioning of code wheel 70 relative to electrode base 51. This convention is followed in other similar Figures throughout the application.

As illustrated in FIG. 4A, code wheel 70 of positioner 75 is rotatably movable relative to electrode base 51 in either a clockwise direction (as indicated by directional arrow A) or a counter-clockwise direction (as indicated by directional arrow B) to rotatably position a conductive spoke 72A-72D of code wheel 70 relative to conductive spokes 50A-50D and non-conductive spokes 60A-60D of electrode base 51. In one aspect, code wheel 70 is rotatable to any position within a 360 degree circumferential range of motion. In one aspect, a clockwise rotation of code wheel 70 is used to capture user inputs associated with scrolling in one direction through menu 26 of display 14 of electronic device 10 in FIG. 1 while a counter-clockwise rotation of code wheel 70 is used to capture user inputs associated with scrolling in the other direction through menu 26. In another aspect, one direction of scrolling includes scrolling up a page or screen and the other direction includes scrolling down a page or screen. In another aspect, one direction of scrolling includes scrolling from left to right while the other direction of scrolling includes scrolling from right to left.

In one aspect, code wheel 70 comprises a passive conductive element that is not tied to ground or a signal source, thereby electrically floating relative to electrode base 51. Accordingly, code wheel 70 is both mechanically and electrically independent of electrode base 51. Upon application of an input signal via drive electrodes 52C of the respective conductive spokes 50A-50D of electrode base 51, the respective conductive spokes 72A-72D of code wheel 70 act to capacitively couple the drive electrodes 52C to a respective first and/or second sense electrodes 52A, 52B. The degree of capacitively coupling generally corresponds to the extent to which the respective conductive spokes 72A-72D of code wheel 70 overlaps the sense electrode portions 52A, 52B of the respective conductive spokes 50A-SOD of the electrode base 51.

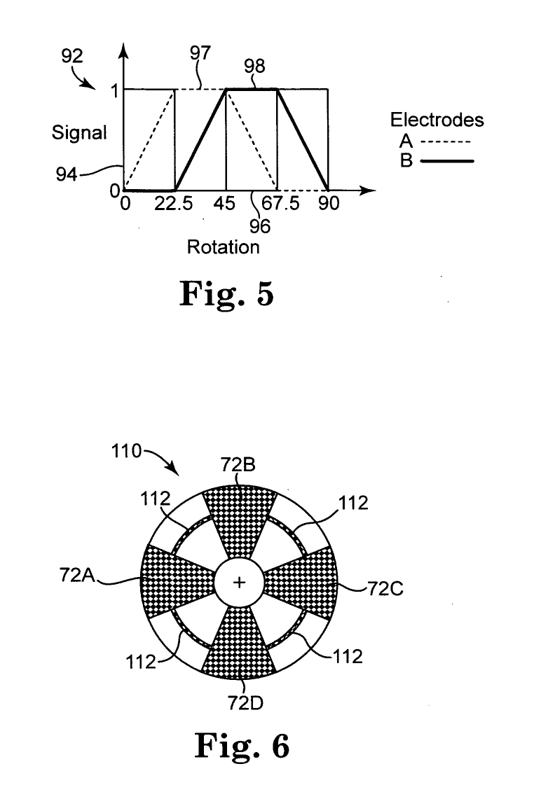

In one aspect, upon application of an input signal via drive electrodes 52C, capacitive coupling of conductive spokes 72A-72D relative to first sense electrodes 52A (of conductive spokes 50A-50D) produces an output signal A and capacitive coupling of conductive spokes 72A-72D of code wheel 70 relative to first sense electrodes 52A (of conductive spokes 50A-50D) produces an output signal B. The magnitude of the respective output signals A and B correspond to the extent to which the conductive spokes 72A-72D of code wheel 70 overlap the respective first and/or second sense electrodes 52A, 52B. Accordingly, a rotational position of code wheel 70 effectively determines the value of the output signals A and B. As further described in association with FIG. 5, an array of user inputs are associated with one or more parameters (e.g., magnitude, slope, etc.) of the output signals A and B to yield a known and selectively variable number of user inputs (e.g., 12, 16, 20) per each full 360 degree rotation of code wheel 70.

In addition, the clockwise or counter-clockwise rotational direction of code wheel 70 is determined based on a comparison of signals A and B, and which signal is leading through a range of rotational positioning.

One rotational position of code wheel 70 is illustrated in FIG. 4A in which each respective conductive spoke 72A-72D of code wheel 70 is vertically positioned directly over first electrodes 52A of each respective electrode spoke 50A-50D, but not over second sense electrodes 52B of the respective conductive spokes 50A-50D. In this position, each conductive portion 72A of code wheel 70 capacitively couples drive electrode 52C relative to first sense electrode 52A.

As illustrated in FIG. 4C, FIG. 4C is a diagram illustrating an equivalent circuit 80 corresponding to the interaction between a conductive spoke 72A of code wheel 70 and the respective electrodes 52A-52C of a conductive spoke 50A of electrode base 51 shown in FIG. 4A, according to one embodiment of the present invention. In one aspect, the portions of conductive spoke 72A that overlap electrodes 52A-52C are represented by electrodes 72A-A, 72A-B, and 72A-DRIVE, respectively, in FIG. 4C. The portion of conductive spoke 72A of code wheel 70 that overlaps first sense electrode 52A forms a parallel plate capacitor having a capacitance C1 that is proportional to that overlap. Similarly, the portion of conductive spoke 72A of code wheel 70 that overlaps second sensor electrode 52B forms a parallel plate capacitor that has a capacitance C2 that is proportional to that overlap B, and so on. Because all of the capacitors share portions of conductive spoke 72A of code wheel 70, the equivalent circuit 80 comprises three capacitors connected to a common conductor shown at 84, generally corresponding to conductive spoke 72A of code wheel 70 in FIG. 4A. By measuring the overlap capacitance between conductive spoke 72A of code wheel 70 and each respective sense electrodes 52A, 52B (when driven to a voltage potential), the rotational position of conductive spoke 72A (and correspondingly a rotational position of code wheel 70) relative to sense electrodes 52A, 52B can be determined.

In one embodiment, this position determination is made by a controller 82, which may be part of the capacitive input device 20 (FIG. 1), or part of the electronic device 10 of which the capacitive input device 20 forms a part. In one embodiment, controller 82 outputs signal 86, which identifies the current position of the code wheel 70.

It will be understood by a person of ordinary skill in the art that functions performed by controller 82 may be implemented in hardware, software, firmware, or any combination thereof. The implementation may be via a microprocessor, programmable logic device, or state machine. Components of the present invention may reside in software on one or more computer-readable mediums. The term computer-readable medium as used herein is defined to include any kind of memory, volatile or non-volatile, such as floppy disks, hard disks, CD-ROMs, flash memory, read-only memory (ROM), and random access memory.

FIG. 5 is a graph illustrating a signal associated with the rotational position of code wheel 70 relative to sense electrodes 52A and 52B of the respective conductive spokes 50A-50D. As illustrated in FIG. 5, a rotational position of code wheel 70 is indicated by a x-axis 96 (labeled ROATION) and a magnitude of output signals A and B associated with the electrode portions 52A and 52B is indicated by a y-axis 94 (labeled SIGNAL). As illustrated in FIG. 5, as each respective conductive spoke 72A-72D of code wheel 70 moves over the respective first sense electrodes 52A, signal A increases until it reaches a maximum when the first sense electrodes 52A are completed overlapped by the respective conductive spokes 72A-72D of code wheel 70. As code wheel 70 is further rotated, the full magnitude of signal A for first sense electrodes 52A is maintained while signal B associated with second sense electrodes 52B rises until a full magnitude of signal B is achieved when conductive spokes 72A-72D completely overlap second sense electrodes 52B. In this position, both first sense electrodes 52A and second sense electrodes 52B are completely overlapped. As code wheel 70 is further rotated, signal A for first sense electrode 52A decreases in proportion to the decrease in the overlap of conductive spokes 72A-72D relative to first sense electrodes 52A. This decrease continues until conductive spokes 72A-72D no longer overlap with first sense electrodes 52A at which time the signal A for first sense electrodes 52A becomes zero. However, signal B for second sense electrodes 52B is maintained at full magnitude as long as second sense electrodes 52B remains completely overlapped by conductive spokes 72A-72D. As code wheel 70 is rotated further, signal B for first sense electrodes 52B decreases as overlap of conductive spokes 72A-72D decreases relative to second sense electrodes 52A. This decrease continues until conductive spokes 72A-72D no longer overlaps with second sense electrodes 52B at which time the signal B for second sense electrodes 52B becomes zero. In addition, at this time signal A has remained with a zero value because conductive spokes 72A-72D of code wheel 70 also do not overlap with first sense electrodes 52A.

In one embodiment, at least four unique user inputs are associated with the different states of the output signals A and B for a 90 degree rotation of code wheel 70. If digital thresholds are defined for high and low signals, typically with a gap between the high threshold and low threshold to provide hysteresis, the following output states can be determined. In one aspect, a first user input is based on a first rotational position of code wheel 70 in which signal A is above the high threshold and signal B is below the low threshold, such as when conductive spokes 72A-72D overlap first sense electrodes 52A but not second sense electrodes 52B (as in FIG. 4A). A second user input is based on a second rotational position of code wheel 70 in which both signal A and signal B are above the high threshold, such as when conductive spokes 72A-72D completely overlap first sense electrodes 52A and second sense electrodes 52B (as in FIG. 4A). A third user input is based on a third rotational position of code wheel 70 in which signal A is below the low threshold and signal B is above the high threshold, such as when conductive spokes 72A-72D overlap first sense electrodes 52A but not second sense electrodes 52B (as in FIG. 4A). A fourth user input is based on a fourth rotational position of code wheel 70 in which both signal A and signal B are below the low threshold, such as when conductive spokes 72A-72D only overlap non-conductive portions 60A-60D of electrode base 51. Accordingly, for an approximately 90 degree rotation of code wheel 70, four user inputs are counted. Following this scheme, additional rotation of code wheel 70 through a full 360 degrees would produce a total of 16 distinct user inputs (or counts) per rotation of code wheel 70.

In another embodiment, user inputs based on distinct rotational positions of code wheel 70 are identified based on intermediate magnitudes (e.g., 25% of full magnitude, 50% of full magnitude, etc.) of signals A and B and/or as based on the slope of the output signals A and B.

Accordingly, a higher or lower resolution of counts per 360 degree rotation of code wheel is selectable based on operator preference and is not necessarily limited by the size (e.g. arc) or the number of repeating sequence of the respective conductive spokes 50A-50D.

As illustrated in FIG. 4B, in one embodiment, code wheel 70 is tiltable from a generally horizontal plane relative to electrode base 51, as illustrated by directional arrow T in FIG. 4B. Tilting is employed to move code wheel 70 into contact with one of the dome switches to activate a function associated with, or highlighted via, the rotational position of code wheel 70 relative to electrode base 51. However, in one aspect, tilting code wheel 70 relative to electrode base 51 changes the gap G, and therefore the capacitance between the conductive spokes 72A-72D of code wheel 70 relative to both the first sense electrodes 52A (or second sense electrodes 52A) and the drive electrode 52C of a respective conductive spoke 50A-50D of electrode base 51. This, in turn, would alter the magnitude of output signals (e.g., output signals A and B) associated with the rotational position of code wheel 70 relative to electrode base 51, thereby potentially distorting the accuracy of inputs that are based on the rotational positions of code wheel.

However, in one embodiment of the invention, each sense electrode is defined into four portions (i.e., first sense electrodes 52A of spaced apart conductive spokes 50A-50D of electrode base 51) that are equally spaced apart from each other by about 90 degrees relative to a 360 degree rotation. In one aspect, with this arrangement, any change in signal caused by tilting of code wheel 70 toward one side of electrode base 51 is generally counteracted by a corresponding, but opposite change in signal on an opposite side of electrode base 51. In another aspect, with this arrangement despite tilting of code wheel 70, the relative signal amplitude corresponding to the rotational position input will remain substantially constant. Accordingly, the equally spaced apart configuration of conductive spokes 50A-50D of electrode base 51 enables the positioner 75 to be relatively insensitive to tilt.

In one embodiment, an input device incorporating positioner 75 of FIG. 4A provides both coarse positioning input and fine positioning input. In one embodiment, coarse positioning input comprises moving up or down a list (e.g., positioning) by sections, groups, or multiple items (e.g., 10) at a time for each consecutive user input. In one aspect, each input of coarse positioning is achieved for each successive activation of one of the respective dome switches (e.g., dome switches 40B and 40D). For example, each activation of dome switch 40B moves items on a list upward 10 items (or another number such as 5 or 15) at a time while each activation of dome switch 40D moves items on a list downward 10 items on the menu at a time. In one embodiment, the pointer is a cursor while in other embodiments the pointer comprises a highlighting function to identify the selected item.

In one embodiment, fine positioning input comprises moving up or down a list one item at a time as controlled by rotational positioning of a positioner 75 including a code wheel 71 rotatable movable relative to an electrode base 51. Each input of the positioner 75 moves a pointer one item up or one item down on the list, with the direction of movement being determined by the clockwise or counterclockwise rotation of the positioner.

In another embodiment, fine positioning input is captured via activation of one of more of the dome switches 40A-40D and coarse positioning input is captured via rotational positioning of a code wheel relative to an electrode base.

In another aspect, these designations of fine positioning input and coarse positioning input are applicable to other embodiments throughout this application.

FIG. 6 is a top plan view of a code wheel 110, according to an embodiment of the invention. As illustrated in FIG. 6, code wheel 110 comprises substantially the same features and attributes as code wheel 70 of FIGS. 3A-4C except additionally comprising a conductor ring 112 that extends about the entire code wheel 110 in a position to continually overlap at least a portion of each of the first sense electrode 52A, second sense electrode 52B, and drive electrode 52C of the respective conductive spokes 50A-50D of an electrode base 51. In one aspect, conductor ring 112 of code wheel 110 maintains a substantially continuous capacitive coupling between the respective first sense electrode 52A, second sense electrode 52B, and drive electrode 52C of the respective conductive spokes 50A-50B, and therefore maintains a minimum non-zero output signal regardless of the rotational position of code wheel 110 relative to electrode base 51.

In one aspect, this non-zero output signal produced via conductor ring 112 of code wheel 110 is used to decrease tilt sensitivity of the code wheel. In particular, upon tilting code wheel 110 to activate a dome switch (one of dome switches 40A-40D of electrode base 51), the amount of capacitive coupling increases via conductor ring 112, thereby increasing the magnitude of the output signal relative to the magnitude of the output signal for a non-tilted position of code wheel 110. Upon detecting this change in the output signal without the occurrence of a corresponding change in rotational position of code wheel 110, the controller determines that the change in the output signal is associated with activation of a dome switch (40A-40D) and then disables the output signal based on rotational positioning at the time that the dome switch is being engaged. This arrangement prevents capturing false rotational positioning input (caused by tilting of code wheel 110) during activation of a dome switch.

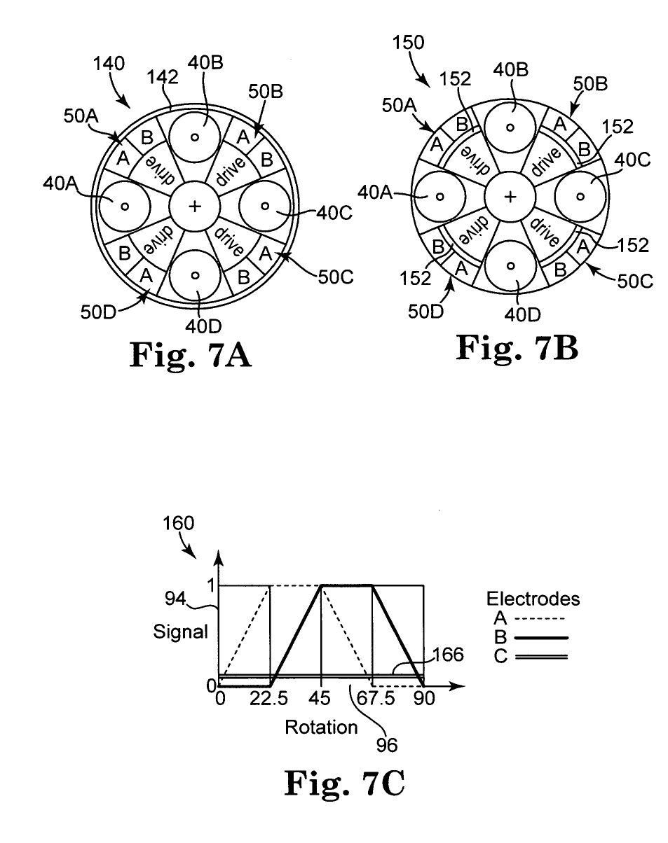

FIG. 7A is a top plan view of an electrode base 140, according to an embodiment of the invention. In one embodiment, electrode base 140 comprises substantially the same features and attributes as electrode base 51 previously described and illustrated in association with FIGS. 3A-5, except further comprising a third channel electrode ring 142. As illustrated in FIG. 7A, third channel electrode ring 142 extends about a circumference of disc shaped electrode base 140 to define an outer edge of electrode base 142. Third channel electrode ring 142 enables, as illustrated in diagram 160 of FIG. 7C, a minimum non-zero output signal 166 independent of the rotational position of a code wheel (e.g., code wheel 70) relative to electrode base 140.

In one embodiment, electrode base 140 is operatively coupled to a code wheel like code wheel 110 except having its conductor ring 112 of code wheel 110 arranged circumferentially adjacent an outer edge of code wheel 110 to generally correspond to the size and shaped of third channel electrode ring 142 of electrode base 140 illustrated in FIG. 7A.

In one aspect, a non-zero output signal achieved via third channel electrode ring 142 of electrode base 140 is used in addition to the non-zero output signal achieved via conductive ring 112 of code wheel 110 to further decrease tilt sensitivity of the code wheel. In another aspect, this non-zero output signal achieved via electrode ring 142 allows for more accurate assessment of intermediate rotational overlapping positions of conductive portions of code wheel 110 relative to electrodes (e.g., sense electrodes 52A, 52B) of an electrode base (e.g., electrode base 51). In particular, upon tilting code wheel 110 (FIG. 6) to activate a dome switch (one of dome switches 40A-40D), the amount of capacitive coupling increases via conductor ring 112 and via third channel electrode ring 142, thereby increasing the magnitude of the output signal relative to the magnitude of the output signal for a non-tilted position of code wheel 110. Again, upon detecting an output change during activation of a dome switch without a corresponding change in rotational position, the controller determines that the output change is associated with activation of a dome switch (40A-40D) and then disables capture of rotational positioning inputs while the dome switch is being engaged. This arrangement minimizes capture of false rotational positioning inputs during activation of a dome switch. Accordingly, this embodiment provides enhanced neutralization of tilt sensitivity of a code wheel (e.g., code wheel 110) relative to an electrode base (e.g., electrode base 140).

FIG. 7B is a top plan view of an electrode base 150, according to an embodiment of the invention. In one embodiment, electrode base 150 comprises substantially the same features and attributes as electrode base 140 previously described and illustrated in association with FIG. 7A, except further comprising third channel electrode ring 152 (instead of third channel electrode ring 142) extending in a generally circular pattern about disc shaped electrode base 150. In one aspect, third channel electrode ring 152 is positioned between the sense electrode 52A, 52B and the drive electrode 52C of each respective conductive spoke 50A-50D. Third channel electrode ring 152 enables, as illustrated in FIG. 7C, a minimum non-zero signal independent of the rotational position of a code wheel (e.g., code wheel 70) relative to electrode base 150. Accordingly, in substantially the same manner as third channel electrode ring 142 of electrode base 140 of FIG. 7A, third channel electrode ring 152 further neutralizes tilt sensitivity of a code wheel relative to an electrode base to insure accurate rotational positioning during activation of a dome switch.

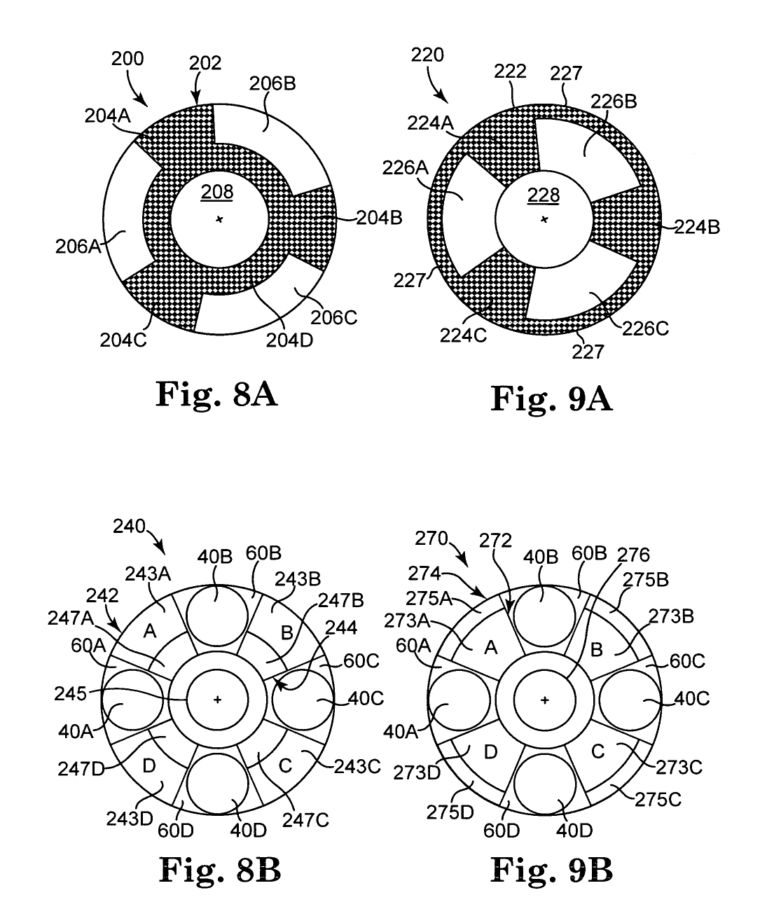

FIG. 8A is a top plan view of a code wheel 200, according to an embodiment of the invention. In one embodiment, code wheel 200 comprises substantially the same features and attributes as code wheel 70 previously described and illustrated in association with FIGS. 3A-5, except having a different number (and differently sized) of conductive spokes 204A-204C and including a center conductor portion 204D. In one embodiment, code wheel 200 comprises an array of conductive spokes 204A-204C arranged in a hub-spoke pattern with each conductive spoke extending radially outward from a conductive center ring portion 204D. In one aspect, center ring portion 204D is a generally annular shaped member defining a central hole 208. In one aspect, conductive spokes 204A-204C are equally spaced apart circumferentially about code wheel 200 with a plurality of non-conductive portions 206A-206C interposed between adjacent conductive spokes 204A-204C.

In one aspect, code wheel 200 comprises three conductive spokes 204A-204C spaced about 120 degrees apart. In another aspect, code wheel 200 comprises a different number, size and/or position of conductive spokes spaced apart from each other by a uniform amount to achieve a 360 degree conductive spoke pattern, as further described later in this application.

FIG. 8B is a top plan view of an electrode base 240, according to an embodiment of the invention. In one embodiment, electrode base 240 comprises substantially the same features and attributes as electrode base 51 previously described and illustrated in association with FIGS. 3A-5, except having a different number, size, and position of sense electrodes spokes 243A-243D and an array 244 of drive electrodes 247A-247D. In one embodiment, electrode base 240 comprises a plurality of sense electrode spokes 243A-243D arranged in a hub-spoke pattern with each sense electrode spoke 243A-243D extending radially outward from a center portion of electrode base 240. In one aspect, center portion 245 defines a hole for mounting dome switch 40E. In one aspect, sense electrode spokes 243A-243D are equally spaced apart circumferentially about electrode base 240 with a plurality of non-conductive portions 60A-60C interposed between adjacent sense electrode spokes 243A-243D. In one embodiment, each non-conductive portion 60A-60D of electrode base 240 supports mounting of a respective dome switch 40A-40D. In addition, a plurality of drive electrodes 247A-247D are positioned radially inward, and aligned along a common radial orientation relative to each respective sense electrode spoke 243A-243D.

In one aspect, electrode base 51 comprises an array of four electrode spokes 243A-243D that are spaced apart from each other about 90 degrees, as illustrated in FIG. 8B. In one aspect, conductive spokes 204A-204C of code wheel 200 are sized and shaped to generally correspond to a size, shape, and position of both sense electrode spokes 243A-243D and drive electrodes 247A-247D of a corresponding electrode base 240.

In one aspect, center ring portion 204D of code wheel 200 is sized and shaped to generally correspond to a size, shape, and position of a ring shaped pattern formed by drive electrodes 247A-247D of a corresponding electrode base 240. In this aspect, when code wheel 200 is rotatably mounted relative to electrode base 240, drive electrodes 247A-247D are continually coupled to each other via center ring portion 204D of code wheel 200, thereby enabling drive electrodes 247A-247D to function as a single common drive electrode without forming a continuous ring on electrode base 240. This arrangement, in turn, enables more space on electrode base 240 for mounting of dome switches 40A-40D in the non-conductive portions 60A-60D because the drive electrodes 247A-247D do not cross the non-conductive portions 60A-60D of electrode base 240 on which the dome switches 40A-40D are mounted.

Application of code wheel 200 and electrode base 240 together for capturing user inputs based on rotational positioning are described later in more detail in association with FIG. 10.

FIG. 9A is a top plan view of a code wheel 220, according to an embodiment of the invention. In one embodiment, code wheel 220 comprises substantially the same features and attributes as code wheel 70 previously described and illustrated in association with FIGS. 3A-5, except having a different number, size, and position of conductive spokes 224A-224C and including an outer ring conductive portion 227. In one embodiment, code wheel 220 comprises a plurality of conductive spokes 224A-224C arranged in hub-spoke pattern with each conductive spoke 224A-224C extending radially outward from a center hole portion 228. In one aspect, conductive spokes 224A-224C are equally spaced apart circumferentially about code wheel 220 with a plurality of non-conductive portions 226A-226C interposed between adjacent conductive spokes 224A-224C. The outer ring portion 227 extends about a circumference of code wheel 220, defining an outer edge of code wheel 220. In one aspect, code wheel 200 comprises three conductive spokes 224A-224C spaced about 120 degrees apart.

FIG. 9B is a top plan view of an electrode base 270, according to an embodiment of the invention. In one embodiment, electrode base 270 comprises substantially the same features and attributes as code wheel 70 previously described and illustrated in association with FIGS. 3A-5, except having a different number, size, and position of sense electrode portions and drive electrode portions.

In one embodiment, as illustrated in FIG. 9A, electrode base 270 comprises a plurality of sense electrode spokes 273A-273D arranged in hub-spoke pattern with each electrode spoke extending radially outward from a center portion 276 of electrode base 270. In one aspect, center portion 276 defines a hole for mounting dome switch 40E (not shown). In one aspect, sense electrode spokes 273A-273D are equally spaced apart circumferentially about electrode base 270 with a plurality of non-conductive portions 60A-60C interposed between adjacent sense electrode spokes 273A-273D. In addition, a plurality of drive electrode ring portions 275A-275D are positioned radially outward, and aligned along a common radial orientation relative to each respective sense electrode spoke 273A-273D.

In one aspect, outer conductor pattern 227 of code wheel 220 is sized and shaped to generally correspond to a size, shape, and position of drive electrode spokes 275A-275D of a corresponding electrode base 270. In this aspect, when code wheel 220 is rotatably mounted relative to electrode base 270, drive electrodes 275A-275D are continually coupled to each other via outer conductor pattern 227 of code wheel 220, thereby enabling drive electrode 275A-275D to function as a single common drive electrode without forming a continuous ring on electrode base 270. This arrangement, in turn, enables more space on electrode base 270 for mounting of dome switches 40A-40D in the non-conductive portions 60A-60D of electrode base 270 because the drive electrodes 275A-275D do not cross the non-conductive portions 60A-60D on which the dome switches 40A-40D are mounted.

FIG. 10 is a top plan view of a positioner 300 of an input device, according to an embodiment of the invention. In one embodiment, positioner 300 comprises a code wheel 200 and an electrode base 240, as previously described in association with FIGS. 8A-8B, except operatively coupled together for rotatable positioning of code wheel 200 relative to electrode base 240. As illustrated in FIG. 10, code wheel 200 is rotatable in a clockwise direction (indicated by arrow A) or a counter-clockwise direction (indicated by arrow B). As in the other embodiments, a signal is applied via drive electrodes 247A-247D (hidden from view by conductor pattern 204D of code wheel 200) which becomes capacitively coupled to respective sense electrodes 243A-234D to the extent to which a respective conductive spoke 204A-240C of code wheel 200 overlaps the respective sense electrode spokes 243A-243D of electrode base 240. A magnitude of the output signal for each respective sense electrode spokes 234A-243D is monitored for capturing or registering user inputs as further described below.

Upon rotation of code wheel 200, code wheel 200 moves consecutively over adjacent sense electrode spokes 243A-243D so that each time that a conductive spoke 204A-204C of code wheel 200 substantially completely overlaps one of the respective electrode spokes 243A-243D, a distinct user input is registered. At the same time, one of the other respective conductive spokes 204A-240C may partially overlap one of the other respective sense electrode spokes 243A-243D of electrode base 241. A comparison of the magnitude of the output signals for each respective sense electrode spoke 243A-243D is made and a single user input is registered for only one sense electrode spoke at a time with the single user input corresponding to a sense electrode spoke having a substantially higher magnitude output signal than the output signals of other sense electrode spokes. In other words, user inputs are not registered based on the relative degree of overlap or absolute magnitude of output signal, as occurs in the input device of FIGS. 3A-4B.

In another aspect, the number of sense electrode spokes 243A-243D that register a substantially higher magnitude signal is selectable and determined by modifying the width (e.g., arc length) of the respective sense electrode spokes 243A-234D. In one combination, two of the four sense electrode spokes 243A-243D register a “high” magnitude signal while the remaining two of the four sense electrodes 243A-243D register a “low” magnitude signal. In another combination, three of the four sense electrode spokes 243A-243D register a “high” magnitude signal while only one remaining sense electrode of the four sense electrodes 243A-243D registers a “low” magnitude signal.

In one aspect, FIG. 10 illustrates one rotational position (of a 360 degree rotational range of motion) of code wheel 200 corresponding to registering a user input. In this rotational position, conductive spoke 204A of code wheel 200 is in generally complete overlap with sense electrode spoke 243B of electrode base 240 while at the same time, conductive spoke 204B of code wheel 200 only partially overlaps (e.g., 50% or less overlap) sense electrode spoke 243C of electrode base 240 and conductive spoke 204C of code wheel 200 only partially overlaps (e.g., 50% or less overlap) sense electrode spoke 243C of electrode base 240. A single user input is registered for this rotational position based on detection of a substantially greater magnitude output signal for sense electrode spoke 243B relative to the lesser magnitude output signals for sense electrode spokes 243A and 243C.

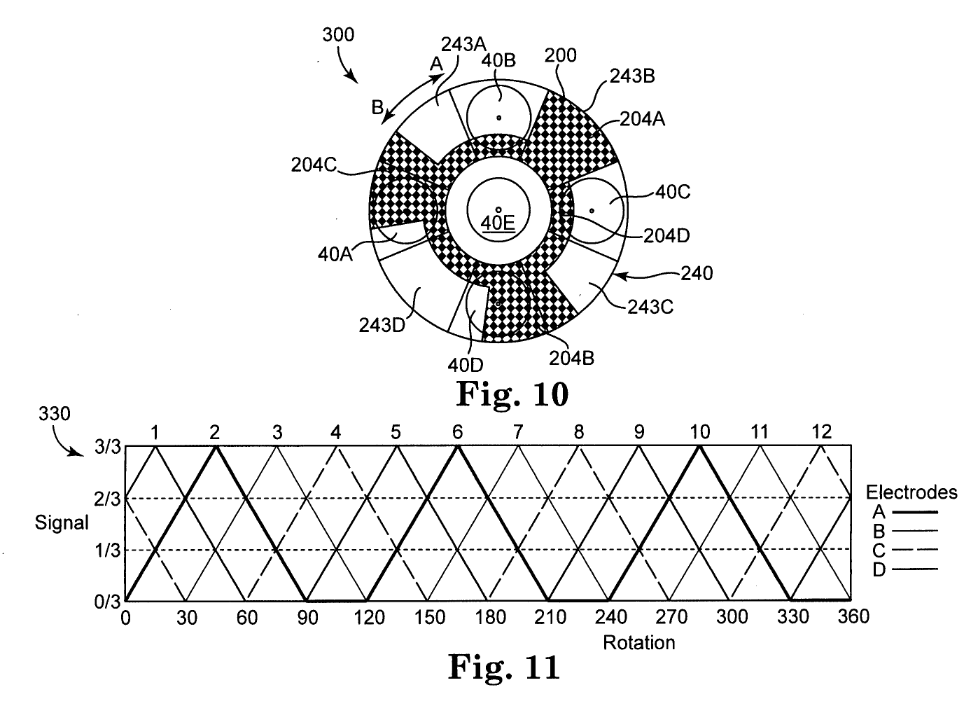

FIG. 11 is a graph 330 illustrating how the amplitude (shown on the y-axis labeled SIGNAL) of the output signal varies according to a rotational position (shown on the x-axis labeled ROTATION) of the code wheel 200 relative to the electrode base 240. As illustrated in FIG. 11, for every 30 degrees of rotation, one conductive spoke of code wheel 200 overlaps a sense electrode spoke of electrode base 240, so that for a complete 360 degree rotation (the full length of x-axis), there are 12 unique maximum signal points. In one aspect, in a fine positioning input mode, each respective maximum signal point for positioner 300 over a full 360 degree rotation of code wheel 200 corresponds to a different item 27 on a list 26 (on display 14 of device 10 in FIG. 1).

In one aspect, the number of user inputs (e.g., 8, 12, 15, etc.) for positioner 300 per full rotation of a code wheel is determined by and is selectable the number, size, and position of conductive spokes of code wheel relative to the number, size, and position of sense electrode spokes of an electrode base. Accordingly, once the number, size, and position of these elements are chosen for a particular positioner, then the number of user inputs for that positioner becomes fixed. This arrangement is in contrast to the embodiment of FIG. 3A-4C in which number of user inputs is primarily determined by sensing an absolute magnitude of an output signal for each sense electrode (e.g. sense electrodes 52A, 52B) and then interpolating the degree of overlap of the conductive portions of the code wheel relative to the sense electrodes of the electrode base to determine which user input is to be registered.

In one embodiment, the arrangement illustrated in FIG. 10 yields a substantially digital signal pattern in that an input is identified when only a single electrode is completely overlapped rather than measuring a degree of overlap of an electrode and the slope of an output signal corresponding to a partially overlapped sense electrode. In one aspect, the substantially digital signal pattern is achieved because no other electrode is being significantly overlapped at the same time that one sense electrode is being substantially or completely overlapped (having a maximum signal).

In addition, in another aspect, a rotational position input is identified by a comparison of the output signal at the four electrodes to determine which electrode spokes is overlapped and has a substantially large output signal relative to a relatively small output signal at the other electrode spokes. This method is in contrast to one conventional measure of identifying a positive input based on whether an amplitude of the signal exceeds a predetermined output threshold.

In another aspect, positioner 300 enables capturing rotation-based user inputs that are relatively insensitive to the capacitive effect of placing a finger on code wheel 200 because a change in the magnitude of the output signal (due to a finger-applied capacitive change) for a given rotational position does not substantially alter the comparison of the output signals between the different sense electrode spokes for determining which sense electrode spoke corresponds to the intended user input. This arrangement is in contrast to other embodiments (e.g. FIGS. 3A-4A) in which the accuracy of absolute measurements of output signals that correspond to identifying user inputs are affected by the capacitive effect of a finger applied to a code wheel.

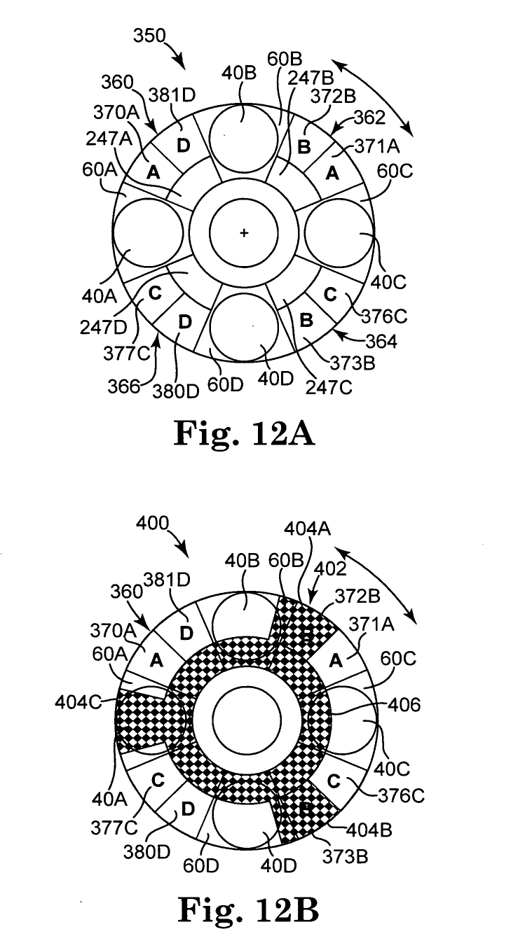

FIG. 12A is a top plan view an electrode base 350, according to an embodiment of the invention. In one embodiment, electrode base 350 comprises substantially the same features and attributes as electrode base 240 previously described and illustrated in association with FIGS. 8B and 10, except having a different arrangement of sense electrode portions 370A, 371A, 372B, 373B, 376C, 377C, 380D, and 381D than sense electrode portions 243A-243D of electrode base 240 of FIGS. 8B, 10. In one embodiment, electrode base 350 comprises spokes 360, 362, 364, and 366 with each spoke 360-366 including a respective drive electrode portion 247A-247D. In one aspect, dome switches 40A-40E are mounted on non-conductive spokes 60A-60D of electrode base 350 in an interposed, alternating pattern relative to the electrode spokes 360-366.

In one aspect, electrode base 350 comprises four spokes 360-366 with each spoke including a pair of sense electrode portions but with each member of the pair belonging to a different sense electrode. Accordingly, as illustrated in FIG. 12A, a first sense electrode A includes first portion 370A and second portion 371A, a second sense electrode B includes first portion 372B and second portion 373B, a third sense electrode C includes first portion 376C and second portion 377C, and a fourth sense electrode D including first portion 380D and second portion 381D. In one aspect, the first portion 370A and second portion 371A of the first sense electrode A are circumferentially spaced apart from each other with first portion 372B of second sense electrode B and second portion 381D of a fourth sense electrode D interposed between the first portion 370A and second portion 371A of the first sense electrode A. Likewise, the first portion and second portion of the second, third, and fourth sense electrodes are arranged circumferentially about the electrode base 350 in a substantially similar manner.

FIG. 12B is a top plan view of a positioner 400, according to one embodiment of the invention. In one embodiment, positioner 300 comprises a code wheel 402 and an electrode base 350 (FIG. 12A) with code wheel 402 rotatably mounted relative to electrode base 350. In one embodiment, code wheel 402 comprises substantially the same features and attributes as code wheel 200 of FIGS. 8A and 10, except having differently sized conductive spokes 404A-404C and a conductor pattern 406 like conductor pattern 206.

As illustrated in FIG. 12B, code wheel 200 is rotatable in a clockwise direction or a counter-clockwise direction. As in the other embodiments, a signal is applied via drive electrodes 247A-247D (hidden due to conductor pattern 406 of code wheel 402) which become capacitively coupled to respective sense electrodes 370A, 371A, 372B, 373B, 376C, 377C, 380D, and 381D based on the extent to which a respective conductive spoke 404A-404C of code wheel 402 overlaps the respective sense electrode portions 370A, 371A, 372B, 373B, 376C, 377C, 380D, and 381D. A magnitude of the output signal for each respective first sense electrode A (portions 370A, 371A), second sense electrode B (portions 372B, 373B), third sense electrode C (portions 376C, 377C), and fourth sense electrode D (portions 380D, 381D) is monitored for capturing or registering user inputs in a manner substantially the same as previously described in association with FIGS. 8A-8B and 10-11.

In one aspect, FIG. 12B illustrates just one rotational position (of a 360 degree rotational range of motion) of code wheel 402 relative to electrode base 350 that corresponds to registering a user input. In this rotational position, conductive spoke 404A of code wheel 402 is in generally complete overlap with first sense electrode portion 372B of electrode base 350 and conductive spoke 404B of code wheel 402 is in generally complete overlap with second sense electrode portion 373B of electrode base 350 (that is spaced apart from first sense electrode portion 372B). At substantially the same time, conductive spoke 404C of code wheel 402 does not overlap any other sense electrode portion of electrode base 350. A single user input is registered for this rotational position based on a substantially greater magnitude output signal for portions 372B and 373B of the same sense electrode relative to the lesser magnitude output signals for portions 370A, 371A, 376C, 377C, 380D, and 381D of the other sense electrodes.

In one aspect, in a manner substantially the same as for positioner 300 of FIG. 10, the number of user inputs (e.g., 8, 12, 15, etc.) for positioner 400 per full rotation of a code wheel is determined by and is selectable the number, size, spacing, and position of conductive spokes (e.g., 404A-404C) of code wheel 402 relative to the number, size, spacing, and position of sense electrode portions (e.g., portions 370A, 371A, 372B, 373B, 376C, 377C, 380D, and 381D) of electrode base 350.

However, in one aspect, positioner 400 illustrated in FIG. 12B provides a more robust arrangement in which the output signals of the respective sense electrodes are less sensitive to tilting of code wheel 402 (that occurs during activation of a dome switch by pressing code wheel 402 toward one of the dome switches 40A-40D). In particular, by dividing a single sense electrode into two portions (e.g., first portion 370A and second portion 371A) and spacing them apart about the circumference of the electrode base, there are two electrode portions (of the same sense electrode) that independently identify a user input based with each of those two different electrode portions of the same sense electrode having an output signal substantially greater than another other sense electrodes of electrode base 350. In another aspect, at the same time, the electrically connected conductive spokes are positioned above (e.g., overlapping) only a single sense electrode pair, such as conductive spokes 404A, 404B overlapping second sense electrode pair 372A,372B but not overlapping first sense electrode pair 370A,371A, third sense electrode pair 376C,377C, and fourth sense electrode pair 380D, 381D.

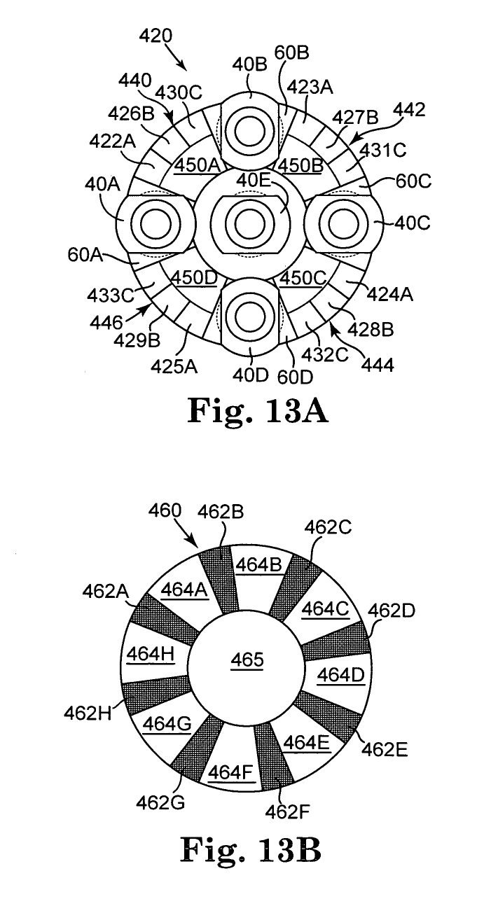

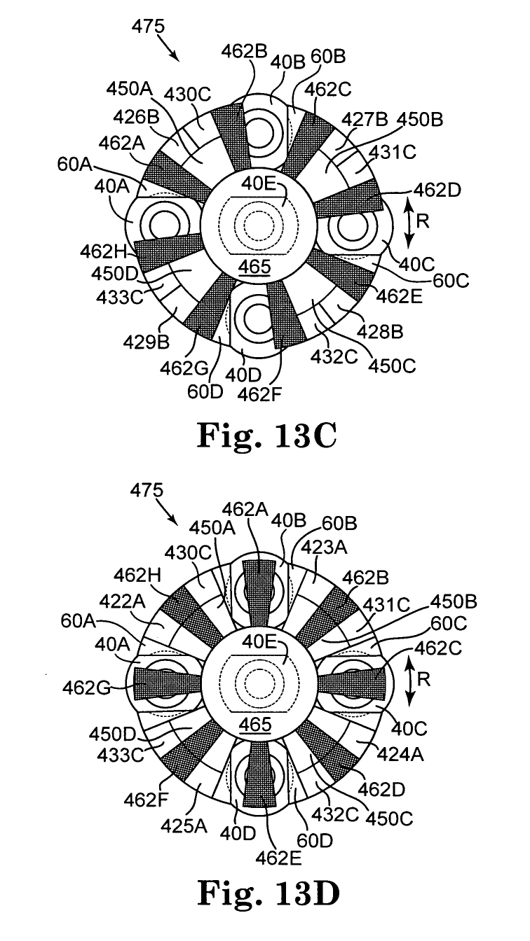

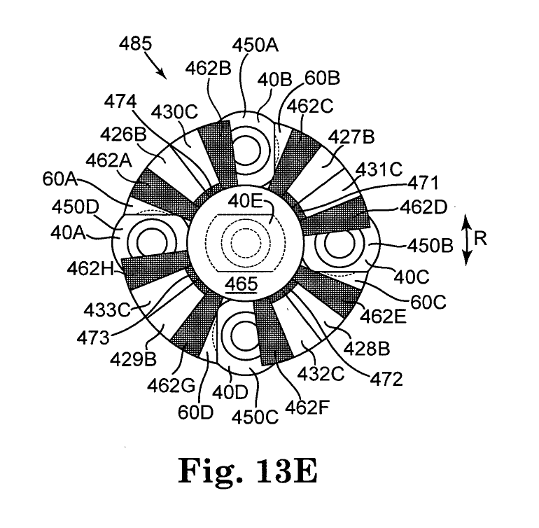

FIG. 13A is a top plan view an electrode base 420, according to an embodiment of the invention. In one embodiment, electrode base 420 comprises substantially the same features and attributes as electrode base 350 previously described and illustrated in association with FIG. 12A, except having a different arrangement of sense electrode portions 422A, 423A, 424A, 425A, 426B, 427B, 428B, 429B, 430C, 431C, 432C, and 433C than sense electrode portions 370A-380D of electrode base 350 of FIG. 12A. In one embodiment, electrode base 420 comprises circumferentially spaced apart spokes 440, 442, 444, 446. In one aspect, each spoke 440-446 includes one of the respective drive electrode portions 450A-450D and one or more sense electrode portions 422A-433C. For example, spoke 440 of electrode base 420 comprises drive electrode portion 450A and sense electrode portions 422A, 426B, and 430C.

In one aspect, dome switches 40A-40E are mounted on non-conductive portions (e.g., spokes) 60A-60D of electrode base 420 in an interposed, alternating pattern relative to the spokes 440-446.

In one aspect, electrode base 420 comprises four spokes 440-446 with each spoke including a trio of sense electrode portions. As illustrated in FIG. 13A, a first sense electrode A includes first portion 422A, second portion 423A, third portion 424A, and fourth portion 425A. In one aspect, a second sense electrode B includes first portion 426B, second portion 427B, third portion 428B, and fourth portion 429B. In one aspect, a third sense electrode C includes first portion 430C, second portion 431C, third portion 432C, and fourth portion 433C. In one aspect, the respective sense electrode portions 422A-425A of the first sense electrode are circumferentially spaced apart from each other about 90 degrees apart from each other. In another aspect, the respective sense electrode portions 426B-429B of the second sense electrode are circumferentially spaced apart from each other about 90 degrees apart from each other. In another aspect, the respective sense electrode portions 430C-433C of the third sense electrode are circumferentially spaced apart from each other about 90 degrees apart from each other.

In addition, on each respective electrode spoke 440-446, the first portions of each respective sense electrode are arranged side-by-side to each other in series. For example, for spoke 440, first portion 422A of first sense electrode A, first portion 426B of second sense electrode B, and first portion 430C of third sense electrode C are arranged in series circumferentially. In another example, for spoke 442, second portion 423A of first sense electrode A, second portion 427B of second sense electrode B, and second portion 431C of third sense electrode C are arranged in series circumferentially. Finally, for spokes 444 and 446, the first portion, second portion, and third portions of the respective sense electrodes (A, B, C) are arranged circumferentially about electrode base 420 in a substantially similar manner on spokes 444, 446.

In one aspect, each drive electrode portion 450A-450D of a respective spoke (440, 442, 444, 446) is aligned in substantially the same radial orientation on the electrode base 420 as the sense electrode portions of a respective spoke of the electrode base 420.

FIG. 13B is a top plan view of a code wheel 460 of an input device, according to one embodiment of the invention. In one embodiment, code wheel 460 comprises substantially the same features and attributes as code wheel 70 of FIG. 3B as well additional features described in association with at least FIGS. 6, 8A, and 10. Accordingly, code wheel 460 defines an upper portion of the input device that is rotatable relative to the generally stationary electrode base 420.

In one embodiment, as illustrated in FIG. 13B, code wheel 460 comprises a generally annular shaped disc including hub 465, a plurality of conductive portions (e.g., spokes) 462A-462H (which are spaced apart circumferentially about code wheel 460), and a plurality of non-conductive portions 464A-464H (which are interposed between adjacent conductive spokes 462A-462H). Each conductive portion 462A-462H extends radially from hub 465. This arrangement achieves an alternating pattern between respective conductive portions 462A-462H and the respective non-conductive portions 464A-464H. In one aspect, each respective conductive portions 462A-462H has a width (e.g., an arc) of about 15 degrees with the conductive portions 462A-462H being circumferentially spaced apart about 30 degrees from each other with non-conductive portions 464A-464H interposed between the adjacent conductive portions 462A-462H.

In one embodiment, hub 465 comprises a central hole while in other embodiments, hub 465 comprises a central solid member.

FIG. 13C is a top plan view of a positioner 475, according to one embodiment of the invention. In one embodiment, positioner 475 comprises code wheel 460 (FIG. 13B) and electrode base 420 (FIG. 13A) with code wheel 460 vertically spaced from and rotatably mounted relative to electrode base 420.

As illustrated in FIG. 13C, code wheel 460 is rotatable in a clockwise direction or a counter-clockwise direction. As in the other embodiments, a signal is applied via drive electrodes 450A-450D which become capacitively coupled to respective sense electrode portions 422A-425A, 426B-429B, and 430C-433C, based on the extent to which a respective conductive portions 462A-462H of code wheel 460 overlaps the respective sense electrode portions 422A-425A, 426B-429B, 430C-433C. A magnitude of the output signal for each respective first sense electrode (portions 422A-425A), second sense electrode (portions 426B-429B), and third sense electrode (portions 430C-433C) is monitored for capturing or registering user inputs in a manner substantially the same as previously described in association with FIGS. 10-11. In other words, positioner 475 enables capturing user inputs in a substantially digital manner based on the position of the conductive portions of the code wheel 460 relative to the sense electrodes of the electrode base 420.

In one aspect, FIG. 13C illustrates just one rotational position (of a 360 degree rotational range of motion) of code wheel 460 relative to electrode base 420 that corresponds to registering a user input. In this rotational position, conductive spoke 462A of code wheel 460 is in generally complete overlap with first sense electrode portion 422A of electrode base 420 and conductive portion 462C of code wheel 460 is in generally complete overlap with second sense electrode portion 423A of electrode base 420 (that is spaced apart from first sense electrode portion 422A). In addition, in this same single rotational position, conductive portion 462E of code wheel 460 is in generally complete overlap with third sense electrode portion 424A of electrode base 420 and conductive portion 462G of code wheel 460 is in generally complete overlap with fourth sense electrode portion 425A of electrode base 420. At substantially the same time, the remaining conductive portions of code wheel 460 do not overlap or substantially overlap any remaining sense electrode portions of electrode base 420. Accordingly, in this example as illustrated in FIG. 13C, a single user input is registered for this rotational position based on a substantially greater magnitude output signal for sense electrode portions 422A, 423A, 424A, 425A of sense electrode A relative to the lesser magnitude output signals for sense electrode portions 426B-433C of the other sense electrodes. Consequently, positioner 475 acts like a digital input mechanism substantially as previously described in association with FIGS. 10-11.

In one aspect, in a manner substantially the same as for positioner 300 of FIG. 10, the number of user inputs (e.g., 8, 12, 15, etc.) for positioner 475 per full rotation of a code wheel is determined by and is selectable the number, size, spacing, and position of conductive spokes (e.g., 462A-462H) of code wheel 460 relative to the number, size, spacing, and position of sense electrode spokes (e.g., portions 422A-425A, 426B-429B, 430C-433C) of electrode base 420. In one aspect, as illustrated in FIG. 13C, the eight conductive portions 462A-462H of code wheel 460 and the three sense electrodes A, B, C with their previously described spacing and size yield up to 24 user inputs for a full 360 degree rotation of the code wheel 460 relative to electrode base 420.

However, in one aspect, positioner 475 illustrated in FIG. 13C provides a more robust arrangement in which the output signals of the respective sense electrodes are less sensitive to tilting of code wheel 460 (that occurs during activation of a dome switch by pressing code wheel 460 toward one of the dome switches 40A-40D). In particular, by dividing a single sense electrode into four portions (e.g., first portion 422A, second portion 423A, third portion 424A, and fourth portion 425A) and spacing them apart about the circumference of the electrode base 420, there are four electrode portions (of the same sense electrode) that independently identify a user input based with each of those four different electrode portions of the same sense electrode having an output signal substantially greater than another other sense electrodes of electrode base 420.

FIG. 13D is a top plan view of positioner 475 with code wheel 460 in another rotational position that corresponds to registering a user input. FIG. 13D illustrates that upon rotation of code wheel 460 to a different rotational position relative to electrode base 420, a different combination of sense electrode portions (e.g., sense electrode portions B including portions 426B, 427B, 428B, and 429B) are overlapped by half of the conductive portions 462A-462H of code wheel 360. For example, in this rotational position, conductive spoke 462H of code wheel 460 is in generally complete overlap with first sense electrode portion 426B of electrode base 420, conductive portion 462B of code wheel 460 is in generally complete overlap with second sense electrode portion 427B of electrode base 420 (that is spaced apart from first sense electrode portion 426B), and so on. At substantially the same time, the remaining conductive portions 462A, 462C, 462E, 462G of code wheel 460 do not overlap (or only slightly overlap) any sense electrode portions of electrode base 420.

Accordingly, in this embodiment, at a given time, four conductive portions of code wheel 460 that are spaced 90 degrees apart overlap each sense electrode portion (e.g., 426B, 427B, 428B, 429B) for a single sense electrode (B) to positively capture a user input associated with that rotational position of code wheel 460.

FIG. 13E is a top plan view of a positioner 485 of an input device, according to an embodiment of the invention. In one embodiment, positioner 485 comprises substantially the same features and attributes as positioner 475 (as described in association with FIGS. 13A-13D) except having a different arrangement of the respective dome switches 40A-40E of electrode base 420 relative to drive electrodes 450A-450D and a pairing of adjacent conductive portions of the code wheel 460. In one aspect, as illustrated in FIG. 13E, each respective drive electrode 450A-450D is located below or incorporated within a corresponding respective dome switch 40A-40D (e.g., drive electrode 450D and dome switch 40A, drive electrode 450A and dome switch 40B, drive electrode 450B and dome switch 40C, and drive electrode 450C and dome switch 40D). In another aspect, each respective sense electrode portion (422A-425A, 426B-429B, 430C-433C) extends substantially completely from the hub 465 out to the periphery of code wheel 460 without a drive electrode portion sharing a radial orientation with the sense electrode portions (as occurs in the embodiments of FIGS. 1-12B). Instead, the respective drive electrodes 450A-450D are positioned circumferentially adjacent to, and interposed between, the spokes of the respective sense electrode portions to be co-located with the respective dome switches 40A-40D.

In addition, code wheel 420 includes a modification in which adjacent conduction spoke portions are electrically connected to each other. In one example, conductive portion 462A is linked to conductive portion 462B via conductive link 474, conductive portion 462C is linked to conductive portion 462D via conductive link 471, conductive portion 462E is linked to conductive portion 462F via conductive link 472, and conductive portion 462G is linked to conductive portion 462H via conductive link 473.

Accordingly, as shown in FIG. 13E, when a particular sense electrode portion (e.g., portion 423A) of electrode base 420 is overlapped by a conductive portion 462C of code wheel 460 to identify a rotational position input, this input is captured via capacitive coupling of sense electrode portion 423A to drive electrode portion 450B via the linked conductive portion 462D of code wheel 460, which overlaps drive electrode portion 450B.

This embodiment enable simplification of the structure of the sense electrode portions and enables an increase in the surface area of the respective sense electrode portions.

In addition, in another embodiment in which the drive electrode portions are incorporated into the respective dome switches, a controller (such as controller 82 in FIG. 4) is configured to generate a waveform adapted to operate the dome switches 40A-40E as a drive electrode and to also operate the dome switches 40A-40E as switches for activating a function of the electronic device.

FIG. 14A is a side view of an input device 500, according to an embodiment of the invention. FIG. 14B is a front plan view of the input device of FIG. 14A, according to an embodiment of the invention. FIG. 14A illustrates input device 500 including a scroll wheel 501 comprising a code wheel 70 and an electrode base 520. Code wheel 70 comprises substantially the same features and attributes as code wheel 70, as previously described in association with FIGS. 3A-5. Electrode base 520 comprises adjacent sense electrodes 522A and 522B and drive electrode 522C in a manner substantially the same as sense electrodes 52A, 52B and drive electrode 52C of electrode base 51 in FIGS. 3A-5. As previously described in association with FIGS. 3A-5, rotational movement (represented by directional scroll arrows A and B) of scroll wheel 501 enables capturing a user input based on a rotational position of code wheel 70 that is capacitively coupled relative to electrode base 520. In one embodiment, electrode base 520 is mounted on an upright support 530 and base 540.

In this embodiment, as illustrated in FIGS. 14A-14B, in addition to measuring a rotational input, input device 500 is configured to capture user inputs based on a tilting of scroll wheel 501 (represented by directional tilting arrows L and R in FIG. 14A) in a direction transverse to the direction of scrolling (represented by directional arrows A and B in FIG. 14B). In one aspect, the degree of tilting causes a corresponding change in the amplitude of coupled capacitance between code wheel 70 and electrode base 520 in proportion to the change in distance (G) of gap 525 between electrode base 520 and code wheel 70 on scroll wheel 501. Accordingly, a tilting to the left corresponds to an increase in an output signal associated with electrode base 520 while a tilting to the right corresponds to a decrease in an output signal associated with electrode base 520.

In this manner, input device 500 enables four way scrolling in which scrolling in a first pair of directions (e.g. A and B) are achieved via measuring a rotational position of the scroll wheel 501 and scrolling in a second pair of other directions (e.g., left and right) are achieved via measuring a tilting position of the scroll wheel 501.

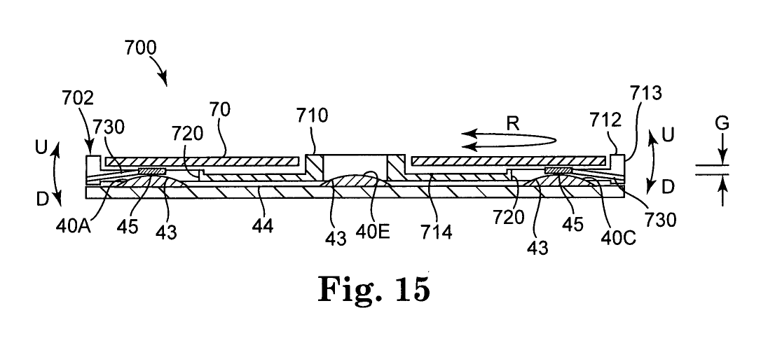

FIG. 15 is a sectional view of an input device 700, according to one embodiment of the invention. As illustrated in FIG. 15, input device 700 comprises code wheel 70 that is rotatably movable relative to and that operatively interacts with an electrode base 44 (such as electrode base 51) having dome switches 40A-40E. In one embodiment, input device 700 comprises tray 702 for rotatably supporting code wheel 70 in a spaced vertical relationship relative to electrode base 44. Accordingly, tray 702 isolates code wheel 70 in a generally mechanically floating position relative to electrode base 44, so that code wheel 70 can rotate freely relative to dome switches 40A-40E.

In one aspect, tray 702 is generally annular shaped member including an inner rim 710 and outer rim 712 defining an outer edge 713. Openings 720 in tray 702 are positioned over each dome switch (e.g. dome switches 40A and 40C in FIG. 15). An arm 730 of tray 702 extends generally inward relative to opening 720 to be positioned over and oriented for contact against center portion 45 of the respective dome switches 40A-40D. Accordingly, upon a tilting motion of code wheel 70 and tray 702 caused by applied finger pressure, arm 730 acts as a dome-actuator to activate one of the respective dome switches 40A-40D.

This arrangement enables the code wheel 70 to be mechanically independent of the electrode base 44 and its dome switches 40A-40D to allow free rotation of code wheel 70, while allowing conventional dome switches (i.e., those not having a protrusion 42 as in FIG. 2) to be used.

Embodiments of the invention provide a low profile input device that accurately captures user inputs for scrolling based on rotational positioning of a code wheel in a manner that is generally less sensitive to tilting of the code wheel, and that occupies a small footprint on an electronic device.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. An input device of an electronic device comprising:
an electrode base including a first array of circumferentially spaced sense electrodes, an array of non-conductive portions interposed between adjacent respective sense electrodes, and at least one drive electrode;
a code wheel rotatably mounted and vertically spaced relative to the electrode base, the code wheel including an array of circumferentially spaced apart conductive portions and an array of non-conductive portions interposed between adjacent respective conductive portions of the code wheel; and
a controller configured to capture user inputs based on an output signal produced via capacitive coupling of the at least one drive electrode of the electrode base, via the code wheel, to the respective sense electrodes of the electrode base.

2. The input device of claim 1 wherein the respective sense electrodes of the electrode base are electrically isolated from each other with each separate sense electrode corresponding to a different output signal, and wherein each respective sense electrode and the at least one drive electrode are positioned along a common radial orientation of the electrode base.

3. The input device of claim 2 wherein the circumferential spacing of the conductive portions of the code wheel relative to the circumferential spacing of the respective sense electrodes of the electrode base is configured to enable, in each rotational position of the code wheel that corresponds to a rotational user input, only one sense electrode of the array of sense electrodes to be completely overlapped by one of the respective conductive portions of the code wheel.

4. The input device of claim 3 wherein each rotational user input is determined by comparing the magnitude of the output signal of the respective sense electrodes of the electrode base relative to each other, wherein the magnitude of the output signal for the one completely overlapped sense electrode is substantially greater than the magnitude of the output signal for the remaining respective sense electrodes.

5. The input device of claim 1 wherein the code wheel comprises an array of circumferentially spaced apart spokes with each respective spoke including at least a first sense electrode portion, and a second sense electrode portion, the first sense electrode portion being electrically isolated from, and arranged side-by-side with, the second sense electrode portion, wherein all of the first sense electrode portions of the respective spokes are electrically coupled to each other and all of the second sense electrode portions of the respective spokes are electrically coupled to each other.

6. The input device of claim 4 wherein each respective spoke includes a first sense electrode portion and a second sense electrode portion, the first sense electrode portion arranged side-by-side with the second sense electrode portion, wherein the first sense electrode portion of the of a first respective spoke is electrically coupled to the second sense electrode portion of a second respective spoke and wherein the second sense electrode portion of the first respective spoke and the first sense electrode portion of the second respective spoke are both interposed between the first sense electrode portion of the first respective spoke and the second sense electrode portion of the second respective spoke.

7. The input device of claim 6 wherein the second sense electrode portion of the first respective spoke is electrically coupled to the second sense electrode portion of a third respective spoke, the first respective spoke circumferentially interposed between the third respective spoke and the second respective spoke.

8. The input device of claim 1 wherein a number of rotational user inputs per a full 360 degree rotation of the code wheel relative to the electrode base is selectable based on a multiplication product of a number of sense electrodes of the array of sense electrodes of the electrode base and a number of conductive portions of the array of conductive portions of the code wheel, the respective sense electrodes being generally equally spaced apart from each other and the respective conductive portions being generally equally spaced apart from each other.

9. The input device of claim 1 wherein the code wheel comprises a conductor pattern extending circumferentially about the code wheel and electrically connecting the respective conductive portions together, and the conductor pattern being electrically isolated from a ground reference.

10. The input device of claim 9 wherein the conductor pattern of the code wheel is sized and shaped to continuously overlap the at least one drive electrode of the electrode base, and wherein the conductor pattern of the code wheel is positioned to continuously overlap both the at least one drive electrode and the respective sense electrodes of the electrode base to cause the output signal to substantially continuously have a non-zero magnitude.

11. The input device of claim 1 and further comprising a plurality of dome switches spaced apart in a generally circular pattern about a circumference of the electrode base with each one of the respective dome switches mounted on each one of the respective non-conductive portions of the electrode base to interpose the respective dome switches between adjacent sense electrodes of the electrode base, the respective dome switches in communication with the controller for activating at least one function of an electronic device.

12. The input device of claim 11 wherein the input device further comprises a tray interposed between the code wheel and the electrode base, the tray configured to guide rotatable movement of the code wheel relative to the electrode base, the tray including at least one arm member configured to establish, upon a tilting motion of at least one of the code wheel and of the tray, pressing contact against the respective dome switch for activating one of the respective dome switches.

13. The input device of claim 11 wherein the at least one drive electrode is co-located with the respective dome switches and interposed between circumferentially adjacent sense electrodes of the electrode base.

14. A method of capturing rotational user inputs for an electronic device, the method comprising:
mounting an electrically passive disc in a rotatable, vertically spaced relationship relative to a stationary base, the disc including a plurality of spaced apart radially oriented conductive portions and the base including a first sense electrode and a first drive electrode arranged along a common radial orientation relative to each other;
sensing a rotational position of the disc relative to the stationary base to capture a rotational user input signal that corresponds to a position signal based on a capacitively coupled overlap between at least one of the conductive portions of the disc relative to both the first sense electrode and the first drive electrode of the base; and
activating a function of the electronic device via a tilting movement of the disc to apply a releasable force against one dome switch of a plurality of dome switches mounted on the first disc, the respective dome switches mounted underneath the disc on the base adjacent to the first sense electrode and the first drive electrode.

15. The method of claim 14 wherein mounting an electrically passive disc comprises:
arranging the stationary base as a generally disc shaped member that comprises a plurality of sense electrodes including the first sense electrode and a plurality of drive electrodes including the first drive electrode; and
arranging the respective sense electrodes to extend radially outward and generally spaced apart from each other and arranging the respective drive electrodes to extend radially outward and generally spaced apart from each other while maintaining each respective sense electrode aligned in a common radial orientation with each respective drive electrode.

16. The method of claim 15 and further comprising:
determining a number of rotational user inputs for a full rotation of the disc relative to the stationary base based on: (1) a quantity of respective conductive portions of the disc; (2) a quantity of the respective sense electrodes of the base; and (3) the relative spacing between adjacent conductive portions of the disc and the relative spacing between adjacent sense electrodes of the base, wherein each respective sense electrode is electrically isolated from each other and corresponds to a different signal component of the position signal.

17. The method of claim 15 and further comprising:
determining a number of rotational user inputs for a full rotation of the disc relative to the base based on identifying different magnitudes of the output signal with each different magnitude corresponding to a relative degree of overlap the respective conductive portions of the disc relative to the respective sense electrodes of the stationary base.

18. The method of claim 17 wherein activating a function of the electronic device comprises interposing the respective dome switches on non-conductive portions of the base between adjacent, spaced apart respective sense electrodes.

19. An electronic device comprising:
a display including a positional identifier viewable on the display;
an input device comprising:
an electrode base including an array of circumferentially spaced apart spokes and an array of non-conductive portions interposed between adjacent respective spokes, wherein each respective spoke comprises at least one sense electrode and a drive electrode;
a code wheel rotatably mounted and vertically spaced relative to the electrode base, the code wheel including an array of circumferentially spaced apart conductive spokes and an array of non-conductive portions interposed between adjacent respective conductive spokes of the code wheel; and
a controller configured to direct movement of the positional identifier in at least one of a first direction and a second direction opposite the first direction, the movement based on a rotational position of the code wheel relative to the electrode base, the rotational user input being determined from an output signal produced via capacitive coupling of the drive electrode of the electrode base, via the code wheel, to the at least one sense electrode of the electrode base, wherein a magnitude of the output signal is determined from a degree of overlap of the respective conductive spokes of the code wheel relative to the respective at least one sense electrodes of the respective spokes of the electrode base.

20. The electronic device of claim 19 wherein the at least one sense electrode of each respective spoke of the electrode base comprises a first portion and a second portion, the second portion being electrically isolated from the first portion and wherein the first portion corresponds to a first sense electrode and the second portion corresponds to a second sense electrode.
